(19) United States
(12) Patent Application Publication
(10) Pub. No.: US 2016/0047697 A1
(43) Pub. Date: Feb. 18, 2016

(54) APPLICATION TEMPERATURE PICKUP DEVICE FOR AUTONOMOUSLY MEASURING THE TEMPERATURE OF A CONTAINER

(71) Applicant: ABB Technology AG, Zurich (CH)

(72) Inventors: Andreas Decker, Darmstadt (DE); Joerg Gebhardt, Mainz (DE); Paul Szasz, Plankstadt (DE); Stephan Wildermuth, Laudenbach (DE)

(21) Appl. No.: 14/826,234

(22) Filed: Aug. 14, 2015

(30) Foreign Application Priority Data
Aug. 14, 2014 (DE) 102014012086.4

(51) Int. Cl. G01K 7/02

(52) U.S. Cl. CPC G01K 7/02

(57) ABSTRACT

An application temperature pickup device is provided for autonomously measuring the temperature of a thermal-energy-having container, with a housing to be secured to the container, a temperature sensor which measures the temperature of a measuring surface of the outer wall of the container and rests thereon, and associated electronics which are arranged in the housing, as well as a thermoelectric generator which conducts away through the flow of heat the thermal energy of a tapping surface of the outer wall of the container and which has the purpose of supplying energy to the temperature sensor and the electronics, wherein the measuring surface is arranged separated from the tapping surface by a distance in order to reduce the exchange of heat with the tapping surface.

### CROSS-REFERENCE TO RELATED APPLICATIONS

Priority is claimed to German Patent Application No. DE 10 2014 012 086.4, filed on Aug. 14, 2014, the entire disclosure of which is hereby incorporated by reference herein.

### FIELD

The present invention relates to an application temperature pickup device for autonomously measuring the temperature of a thermal-energy-having container

### BACKGROUND

The field of use of the invention extends, for example, to industrial systems in which, for example, liquid or gaseous media are conducted or stored in containers such as pipes or tanks. In order to determine the temperature of a fluid contained in such a container, in the prior art either temperature sensors are used which are introduced invasively into the medium in the container within a protective pipe device through openings provided for that purpose, or else temperature sensors are used which rest non-invasively on the outside on the surface of the container and measure the temperature of this surface.

In addition, in the generally known prior art, such application temperature pickup devices are known which additionally have a thermoelectric generator which, in suitable fields of use in which there is a sufficiently high temperature gradient between the container and the environment, uses the thermal energy of the container in order to supply current to the sensor and to the electronics connected to the sensor, such as for example also radio communications systems. This results in an autonomous system, which can be connected to other components entirely without connections or electric lines. A disadvantage of the known prior art is, on the one hand, interaction between the heat-discharging function of the thermoelectric generator and the measuring function of the temperature sensor which is falsified as a result, since the measurement of said temperature sensor is falsified by the thermoelectric generator. Furthermore, such application temperature pickup devices are, in contrast to protective pipes, not fixedly connected by flanges since the latter simultaneously have to seal an opening of the container with respect to the fluid, but instead are normally pressed onto the housing by attachment elements such as, for example, clips or clamps. The weight of the pickup device, which, for example as a result of the cooling element of the thermoelectric generator, can assume values which are relevant for the mechanical stability, has the effect that the entire device, in particular the temperature sensor which is, under certain circumstances, sensitive to mechanical pressure or can be damaged thereby, has to be pressed against the housing with a large force.

### SUMMARY

An aspect of the invention provides an application temperature pickup device for autonomously measuring a temperature of a thermal-energy-having container, the device comprising: a housing configured to be secured to the container; a temperature sensor which measures the temperature of a measuring surface of an outer wall of the container, the temperature sensor resting on the outer wall; associated electronics which are arranged in the housing; and a thermoelectric generator configured to conduct away the thermal energy of a tapping surface of the outer wall of the container through heat flow, wherein the thermoelectric generator is configured to supply energy to the temperature sensor and the electronics, and wherein the measuring surface is arranged separated from the tapping surface by a separating distance, in order to reduce exchange of heat with the tapping surface.

### BRIEF DESCRIPTION OF THE DRAWINGS

The present invention will be described in even greater detail below based on the exemplary figures. The invention is not limited to the exemplary embodiments. All features described and/or illustrated herein can be used alone or combined in different combinations in embodiments of the invention. The features and advantages of various embodiments of the present invention will become apparent by reading the following detailed description with reference to the attached drawings which illustrate the following:

FIG. 1 shows an outline of an embodiment with an axial distance between the measuring surface and the tapping surface on an exposed pipe, and

FIG. 2 shows an outline of an embodiment with an axial distance on an insulated pipe, and

FIG. 3 shows an outline of an embodiment with a heat-conducting element in the form of a hollow cylinder, and

FIG. 4 shows an outline of an embodiment with a distance along the circumference of an insulated pipe.

### DETAILED DESCRIPTION

An aspect of the present invention is to provide an application temperature pickup device which avoids mechanical damage to the sensor by the attachment and reduces or prevents measuring errors caused by the effect of the thermoelectric generator.

An aspect of the invention relates to an application temperature pickup device for autonomously measuring the temperature of a thermal-energy-having container, comprising a housing to be secured to the container, a temperature sensor which measures the temperature of a measuring surface of the outer wall of the container and rests thereon, and associated electronics which are arranged in the housing, as well as a thermoelectric generator which conducts away through the flow of heat the thermal energy of a tapping surface of the outer wall of the container and which has the purpose of supplying energy to the temperature sensor and the electronics.

An aspect of the invention includes the technical teaching that the measuring surface, defined by the resting surface of the temperature sensor, is arranged separated from the tapping surface by a distance in order to reduce the exchange of heat with the tapping surface, that is to say the surface from which thermal energy is conducted to the thermoelectric generator.

An advantage of this technical teaching is that the temperature sensor and the thermoelectric generator are separated or isolated thermally and, independently thereof, also mechanically, from one another.

According to one advantageous development of the invention a thermal insulating means is arranged also at least over parts of the distance between the measuring surface and the tapping surface. This further increases the thermal isolation of the two surfaces.

In one advantageous development of the invention which relates to a container in the form of a pipe which preferably conducts a directed flow, the temperature sensor and therefore the measuring surface are arranged upstream of the tapping surface at an axial distance. Arranging the temperature sensor counter to the flow direction when viewed from the tapping surface has the effect that the conduction away of thermal energy by the thermoelectric generator does not have any influence on the measurement of the temperature sensor. The fluid then firstly passes through the region of the measuring surface and then only through the region of the tapping surface. Furthermore, with such an arrangement along a pipe it is particularly easy to attach the temperature sensor to the pipe with an attachment means running, for example, circumferentially around the pipe, such as a clip, and to attach downstream thereof the thermoelectric generator to the cooling element, housing and electronics with a further clip, if appropriate with a relatively large force in order to bring about a relatively high level of mechanical stability, in such a way that said thermoelectric generator is mechanically isolated therefrom.

Ideally, the axial distance between the measuring surface and the tapping surface here is larger than the radius of the pipe. This improves, in particular, the thermal insulation between the tapping surface and the measuring surface.

According to one measure which improves the invention, the thermoelectric generator is thermally connected to the tapping surface via a heat-conducting element. In particular, if an insulating means is provided on the outer wall of the container, the thermoelectric generator, as well as also the electronics and the housing containing the electronics, can therefore be arranged outside the insulating means, since the heat-conducting element supplies the thermoelectric generator with energy through the insulating means. In this context it is to be noted that the, under certain circumstances, considerable delay which arises as a result of the conduction of heat by the heat-conducting element is in practice entirely irrelevant since the thermoelectric generator is, in contrast to the temperature sensor, not intended to perform a measurement which is resolved over time, since merely the thermal energy which is contained in the container is to be utilized. Such a heat-conducting element can be embodied, for example, as a rod or block composed of a thermally conductive material such as, for example, copper or some other metal.

One advantageous development of the invention provides that in particular in the case of a container on whose outer wall a thermal insulating means is arranged, the temperature sensor which rests on the measuring surface of the container is electrically connected to the electronics arranged outside the insulating means, with electric lines leading through the insulating means. By means of such electric lines it is therefore possible to arrange the measuring surface at any desired distance from the tapping surface.

Another preferred embodiment of the invention provides that the heat-conducting element is embodied in the form of a hollow cylinder and is arranged resting with a distal, front-side end with the tapping surface, and with a proximal front-side end with the thermoelectric generator, the hollow circle-shaped tapping surface being arranged concentrically with respect to the measuring surface. As a result, in particular a very space-saving, compact embodiment of the application temperature pickup device can be constructed. In particular in the case of containers which have small dimensions, this design can be preferable. It is also possible here, as already described, to arrange an additional thermal insulating means in an annular shape in the radial distance between the central measuring surface and the tapping surface which is arranged concentrically thereto in an annular shape.

A further preferred embodiment of the invention is defined in that the separating distance between the measuring surface and the tapping surface is provided at least partially along the circumference of the container which is embodied as a pipe. Ideally, the angle between the tapping surface and the measuring surface is at least 45°, ideally 90° to 180°, or the distance along the circumference is at least one eighth, preferably a quarter or half of the circumference. In this embodiment it is also possible for the thermoelectric generator to rest either directly on the tapping surface or to be arranged at a distance therefrom with an intermediate heat-conducting element.

A further aspect of the invention provides that the temperature sensor and the thermoelectric generator are, if appropriate, attached indirectly to the container via the heat-conducting element via independent attachment means. As a result, in particular mechanical isolation of the temperature sensor and the rest of the application temperature pickup device can be achieved, with the result that, for example, the temperature sensor is pressed onto the measuring surface by a relatively small force which avoids mechanical damage.

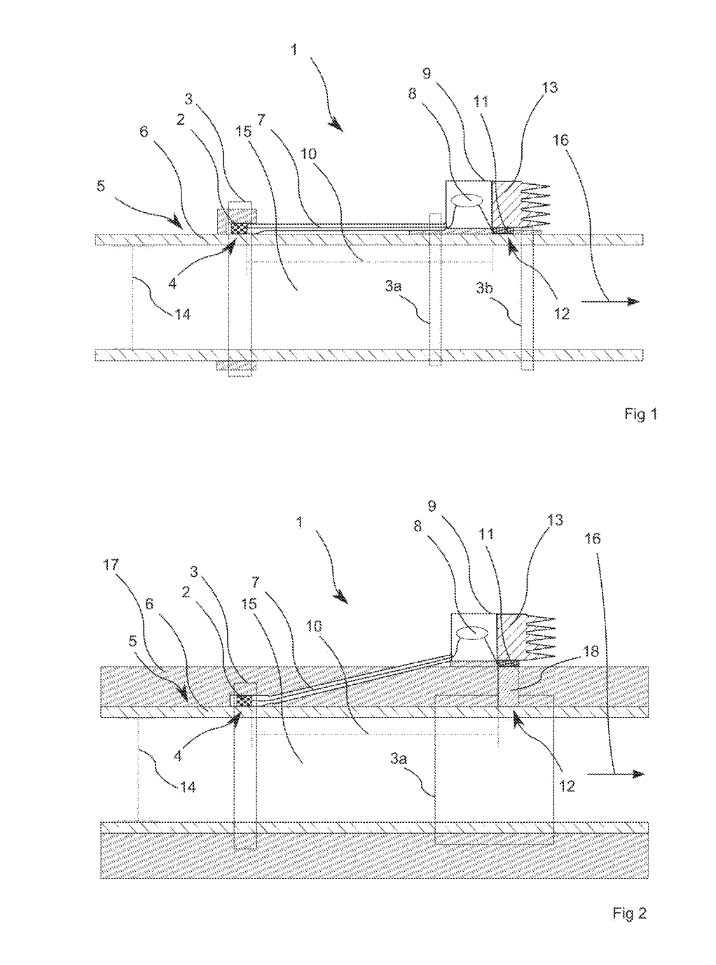

According to FIG. 1, an application temperature pickup device 1 comprises a temperature sensor 2 which is pressed by a first attachment means 3 onto the measuring surface 4 of the outer wall 5 of a container 6, in the form of a pipe, which conducts a fluid 15 in the flow direction 16. The temperature sensor 2 is connected by means of an electric line 7 to electronics 8 which are arranged in a housing 9. In particular, the electric line 7 spans here a distance 10 running axially with the pipe 6. In addition, arranged in the region of the housing 9 is a thermoelectric generator 11 which rests with one side on the tapping surface 12 of the outer wall 5 of the pipe 6 and with another side on a heat sink 13, in order to generate a temperature gradient and to utilize this gradient to generate current to operate the electronics 8 and the temperature sensor 2. In particular, the housing 9 and the thermoelectric generator 11 are connected indirectly to the pipe 6 by further connecting means 3a, 3b. The distance between the temperature sensor 2 or the measuring surface 4 and the thermoelectric generator 11 or the tapping surface 12 is here a multiple of half the diameter 14, that is to say the radius, of the pipe 6. The temperature sensor 2 and thermoelectric generator 11 or measuring surface 4 and tapping surface 12 are therefore largely both mechanically and thermally isolated.

FIG. 2 shows an exemplary embodiment of an application temperature pickup device 1 according to the invention in which, in contrast to the previous example, a thermal insulating means 17 is attached around the circumference of the container in the form of a pipe 6. The electronics 8 arranged in the housing 9 is connected to the temperature sensor 2 by means of an electric line 7 leading through the insulating means 17, and the thermoelectric generator 11 is connected by a heat-conducting element 18 in the form of a copper cylinder to the tapping surface 12 on the outer wall 5 of the pipe 6. The temperature sensor 2 and thermoelectric generator 11 or heat-conducting element 18 are also attached here by various attachment means 3; 3a in the form of clips. The axial distance 10 between the tapping surface 12 and the measuring surface 4 is, as above, a multiple of the radius, that is to say of half the diameter 14, of the pipe 6.

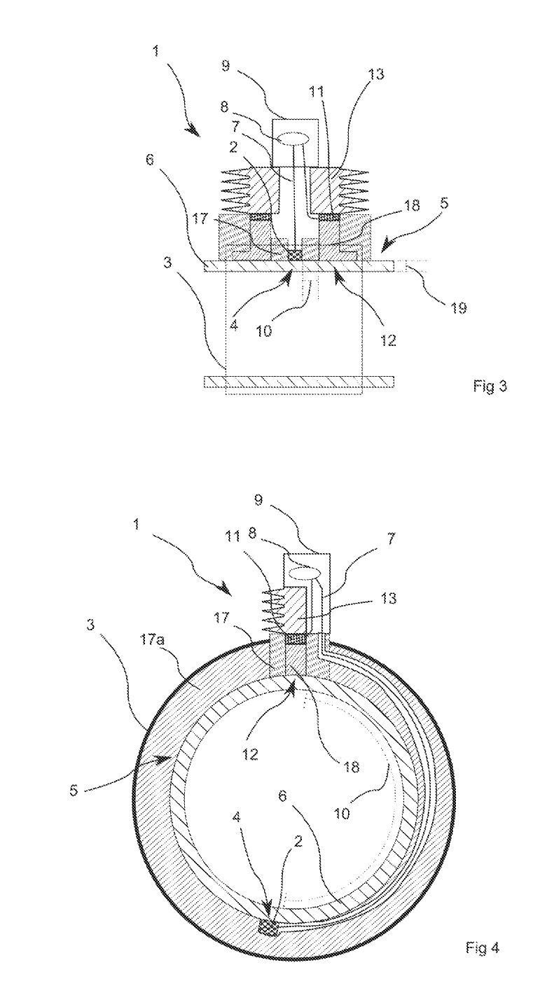

FIG. 3 shows an application temperature pickup device 1 in which a heat-conducting element 18 in the form of a hollow cylinder is pressed by attachment means 3 in the form of a clip onto the outer wall 5 of a container 6 in the form of a pipe which has a wall thickness 19. The heat-conducting element 18 is arranged concentrically here around the measuring surface 4 defined by the temperature sensor 2 resting on it, the radial distance 10 of the region between the measuring surface 4 and the tapping surface 12 defined by the heat-conducting element 18 resting on it being larger than the wall thickness 19 of the pipe 6. In the free distance 10 between the temperature sensor 2 and the heat-conducting element 12, an insulating means 17 is additionally arranged for the purpose of further thermal insulation. The temperature sensor 2 is attached by means of a thermally conductive bonding agent (not illustrated) which has to be able to withstand, in particular, only negligible mechanical loads. Arranged on the heat-conducting element 18 are, successively, a thermoelectric generator 11, the coolant 13 thereof for generating a high temperature gradient being arranged thereon, and the housing 9 with the electronics 7 which operate the temperature sensor 2 and pass on the measuring results by radio being arranged thereon in turn. In this embodiment it is possible, in particular, to measure the temperature autonomously, in a mechanically stable fashion and largely free of faults, in particular in a particularly space-saving fashion.

FIG. 4 illustrates the cross section perpendicularly with respect to the axis of a container 6 in the form of a pipe, through this pipe 6 and the application temperature pickup device 1 mounted thereon. A thermal insulating means 17a is provided circumferentially around the pipe 6. An attachment means 3 in the form of a clamp running circumferentially around this insulating means 17a presses the entire application temperature pickup device 1, in particular heat-conducting element 18 and temperature sensor 2, onto the outer wall 5 of the pipe 6. The measuring surface 4 generated thereby and the tapping surface 12 are separated from one another and lie opposite one another, here, in particular, at an angle of virtually 180° or at a distance 10 of almost half the circumference of the pipe 6. An electric line 7 running from the temperature sensor 2 serves to supply current and for the purpose of communication between the temperature sensor 2 and control electronics 8, while a heat-conducting element 18 which is guided through the insulating means 17 makes available the thermal energy of the pipe 6 for the thermoelectric generator 11.

The invention is not restricted to the preferred exemplary embodiments described above. Instead, modifications thereof, which are also included in the scope for protection of the following claims, are also conceivable. It is therefore also possible, for example, for the distance along the circumference between the tapping surface and the measuring surface to be only a quarter, and not half, of the circumference of the pipe. It is also possible for the container not to be embodied as a pipe but rather as a vessel with fluid stored at rest therein.

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below. Additionally, statements made herein characterizing the invention refer to an embodiment of the invention and not necessarily all embodiments.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B, and C” should be interpreted as one or more of a group of elements consisting of A, B, and C, and should not be interpreted as requiring at least one of each of the listed elements A, B, and C, regardless of whether A, B, and C are related as categories or otherwise. Moreover, the recitation of “A, B, and/or C” or “at least one of A, B, or C” should be interpreted as including any singular entity from the listed elements, e.g., A, any subset from the listed elements, e.g., A and B, or the entire list of elements A, B, and C.

### LIST OF REFERENCE NUMBERS

1 application temperature pickup device
2 temperature sensor
3 attachment means
4 measuring surface
5 outer wall
6 container
7 electric line
8 electronics
9 housing
10 distance
11 thermoelectric generator
12 tapping surface
13 heat sink
14 diameter
15 fluid
16 flow direction
17 insulating means
18 heat-conducting element
19 wall thickness

1. An application temperature pickup device for autonomously measuring a temperature of a thermal-energy-having container, the device comprising:
a housing configured to be secured to the container;
a temperature sensor which measures the temperature of a measuring surface of an outer wall of the container, the temperature sensor resting on the outer wall;
associated electronics which are arranged in the housing; and
a thermoelectric generator configured to conduct away the thermal energy of a tapping surface of the outer wall of the container through heat flow,
wherein the thermoelectric generator is configured to supply energy to the temperature sensor and the electronics, and
wherein the measuring surface is arranged separated from the tapping surface by a separating distance, in order to reduce exchange of heat with the tapping surface.

2. The device of claim 1, further comprising:
a thermal insulator, arranged on at least parts of the separating distance between the measuring surface and the tapping surface.

3. The device of claim 1, wherein the container includes a pipe, and
wherein the separating distance is arranged at least partially axially.

4. The device of claim 3, wherein an axial distance between the measuring surface and the tapping surface is larger than half a diameter of the pipe.

5. The device of claim 3, wherein the container is a pipe,
wherein the pipe is configured to conduct an axially directed flow of a fluid, and
wherein the measuring surface is arranged counter to a flow direction of the tapping surface.

6. The device of claim 1, wherein the thermoelectric generator is thermally connected to the tapping surface via a heat-conducting element.

7. The device of claim 6, wherein the container includes a thermal insulator, arranged on the outer wall of the container,
wherein the heat-conducting element leads through the thermal insulator to the thermoelectric generator arranged outside the insulator.

8. The device of claim 1, wherein the container includes a thermal insulator, arranged on the outer wall of the container,
wherein the temperature sensor, which rests on the measuring surface on the container, is electrically connected to the electronics, arranged outside the thermal insulator, via electric lines leading through the insulator.

9. The device of claim 6, wherein the heat-conducting element is in the form of a hollow cylinder, and
wherein the heat-conducting element is arranged resting with a distal, front-side end with the tapping surface, and with a proximal front-side end with the thermoelectric generator,
wherein the tapping surface is hollow and circle-shaped, and
wherein the tapping surface is arranged concentrically with respect to the measuring surface.

10. The device of claim 9, wherein a radial distance between the measuring surface and the tapping surface is larger than a wall thickness of the container there.

11. The device of claim 1, wherein the container is a pipe, and
wherein the separating distance between the measuring surface and the tapping surface is arranged at least partially along a circumference of the container.

12. The device of claim 11, wherein a distance between the measuring surface and the tapping surface along the circumference of the container, in the form of a pipe, is more than an eighth of the circumference.

13. The device of claim 1, wherein the temperature sensor and the thermoelectric generator are attached using independent attachments.

14. The device of claim 1, wherein the container is a pipe.

15. The device of claim 1, wherein the separating distance is arranged at least partially axially.
